(19) United States
(12) Patent Application Publication
(10) Pub. No.: US 2007/0214254 A1
(43) Pub. Date: Sep. 13, 2007

(54) Method and system for topology discovery in an ad hoc network

(76) Inventor: Anatoly Aguinik, Buffalo Grove, IL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/369,505

(22) Filed: Mar. 7, 2006

(51) Int. Cl. G06F 15/173

(52) U.S. Cl. 709/224

(57) ABSTRACT

A method and system for topology discovery in an ad hoc network is useful for reducing unnecessary network signaling messages and improving network efficiency. The method includes receiving, at a first node, a first topology discovery signal transmitted from a second node (step 405). A response shedding rule is then applied to the first node (step 415). Based on the response shedding rule, it is then determined that the first node is eligible to respond to the first topology discovery signal (step 420). In response to the first topology discovery signal, a second topology discovery signal is then transmitted from the first node to the second node (step 425).

### FIELD OF THE INVENTION

The present invention relates generally to ad hoc wireless communication networks, and in particular to inter-node network communications concerning network topology.

### BACKGROUND

Many wireless communication systems require a rapid deployment of independent mobile users as well as reliable communications between users. Mobile Ad Hoc Networks (MANETs) are based on self-configuring autonomous collections of mobile users who communicate with each other over wireless links having limited bandwidths. MANETs are usually temporary packet radio networks which do not involve significant supporting infrastructure. Rather than employing fixed base stations as routers, each user node in a MANET can operate as a router for other user nodes, thus enabling expanded network coverage areas that can be set up quickly, at low cost, and which are highly fault tolerant.

MANETs provide critical communication services in various environments involving, for example, emergency services supporting police and firefighting personnel, military applications, and construction sites. Network topology in a MANET refers to both physical characteristics of individual nodes in the MANET, such as node position, transmitting power, frequency selection, and battery life, and also to inter-node awareness of such physical characteristics. For example, effective MANETs often require a sophisticated network topology where each node in the network is aware of the location and other physical characteristics of every other node in the network. Such sophisticated network topology can enable for example rapid selection of efficient multi-hop communication routes, and the elimination of unnecessary or redundant communications.

Topology discovery concerns the inter-node communication of node locations and other physical characteristics of nodes. Topology discovery is thus generally an ongoing process that continues for each node in a MANET for as long as each node is an active participant in the MANET. In MANETs with a large number of nodes, topology discovery signal traffic—meaning the collection of inter-node communication signals that provide information about network topology—can become congested. Such network signal traffic congestion can result in increased radio frequency interference, a need for signal transmissions at greater power, and a reduced battery life of individual network nodes.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages, all in accordance with the present invention.

FIG. 1 is a schematic diagram of an ad hoc wireless communication network comprising a plurality of communication nodes, according to the prior art.

FIG. 2 is a schematic diagram of an ad hoc wireless communication network comprising a plurality of communication nodes, according to an embodiment of the present invention.

FIG. 3 is a general flow diagram illustrating a method for topology discovery in an ad hoc wireless communication network, from the perspective of an external node, according to an embodiment of the present invention.

FIG. 4 is a general flow diagram illustrating a method for topology discovery in an ad hoc wireless communication network, from the perspective of a current network member node, according to an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to topology discovery in an ad hoc network. Accordingly, the apparatus components and method steps have been represented, where appropriate, by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of topology discovery in an ad hoc network as described herein. The non-processor circuits may include, but are not limited to, a radio receiver, a radio transmitter, signal drivers, clock circuits, power source circuits, and user input devices. As such, these functions may be interpreted as steps of a method to perform topology discovery in an ad hoc network. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein, will be readily capable of generating such software instructions and programs and ICs with minimal experimentation.

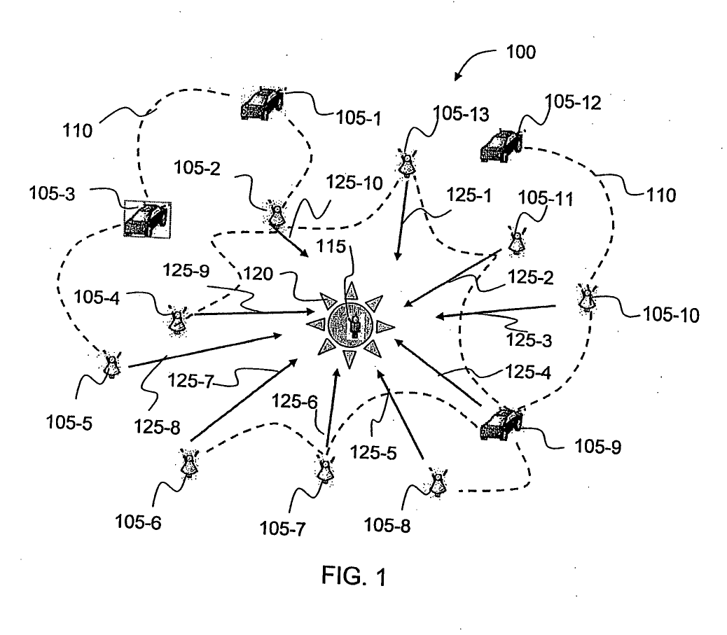

Referring to FIG. 1, there is a schematic diagram of an ad hoc wireless communication network 100 comprising a plurality of current network member nodes 105-n, according to the prior art. The nodes 105-n are communicatively coupled as represented by dashed lines 110, indicating that the nodes 105-n are current members in the network 100. As illustrated, some of the nodes 105-n are operating from individual people who are network users and some of the nodes 105-n are operating from vehicles. An external node 115 is shown surrounded by current network member nodes 105-n but is not connected to any current network member nodes 105-n, indicating that the node 115 is currently not a member of the network 100. A status of being a member of the network 100 may indicate for example that each node 105-n has completed an authentication process with the other nodes 105-n, and that each node 105-n has signaled its presence in the network 100 to the other nodes 105-n. In such an ad hoc network 100 according to the prior art, other nodes such as the external node 115 may be free to join the network 100 simply by completing a network registration process such as a handshake with one or more of the current network member nodes 105-n. Such a registration process can begin with a topology discovery signal such as a simple “hello” message that is transmitted from the external node 115 to a plurality of current member nodes 105-n. The registration process is part of a network topology discovery process where the external node 115 attempts to learn about the existence of and characteristics of the current network member nodes 105-n, so as to determine whether and how to join the network 100.

A “hello” message that initiates a registration process is often broadcast to an Internet Protocol (IP) limited broadcast address. Any existing network member node 105-n that receives the “hello” message is requested to respond to the external node 115. For example, the star burst pattern 120 surrounding the external node 115 indicates a broadcast of a “hello” message from the external node 115 to surrounding current network member nodes 105-n. Ten arrows 125-n pointing toward the external node 115 indicate ten individual responses to the “hello” message from ten individual current network member nodes 105-n. That means that a “hello” message was successfully broadcast from the external node 115 and received by ten of the current network member nodes 105-n. All ten current network member nodes 105-n that received the “hello” message then responded to the external node 115 with some form of network topology discovery signal that provides the external node 115 with information about the network 100 and about how to join the network 100. Detrimentally, such multiple topology discovery signals from the current network member nodes 105-n generally comprise redundant information. In the example illustrated in FIG. 1, that means that nine of the ten responses transmitted by the current network member nodes 105-n may be redundant and/or unnecessary network communications. However, because all ten current network member nodes 105-n were operating within range of the broadcast “hello” message, all ten were obligated under standard network operating protocols to respond. Such unnecessary network communications can have numerous deleterious effects on the network 100, including increased network signal traffic congestion, increased radio frequency (RF) interference, and decreased battery power in the responding member nodes 105-n. A significant problem caused by increased network signal traffic congestion from multiple, simultaneous responses from surrounding network member nodes 105-n are collisions between such responses. In addition to such multiple responses being unnecessary and redundant, such collisions cause extra delays, re-transmissions, and a waste of network resources.

In general, maintaining a high Quality of Service (QoS) for users of ad hoc communication networks requires adherence to various operating principles such as conserving node battery power, maximizing network range, minimizing radio frequency (RF) interference, and minimizing unnecessary transmissions between network nodes. The principles of conserving node battery power, minimizing RF interference, and minimizing unnecessary transmissions between network nodes complement each other. For example, reducing a total number of transmissions in a network directly results in less RF interference, and also conserves battery power at individual network nodes.

As described above, one common source of unnecessary and redundant transmissions between network nodes arises during topology discovery processes. As used in the present specification, the term “topology discovery” concerns any network signaling where a network node communicates with another network node to learn about topology characteristics of the network. Topology characteristics can include, for example, node locations, node transmitting power, the existence of a node, node battery status, the willingness of a node to act as an intermediate node for relaying transmissions between other nodes, received signal strength indicators (RSSIs), levels of network signal traffic congestion, a number of nodes participating in a network, and levels of radio frequency interference.

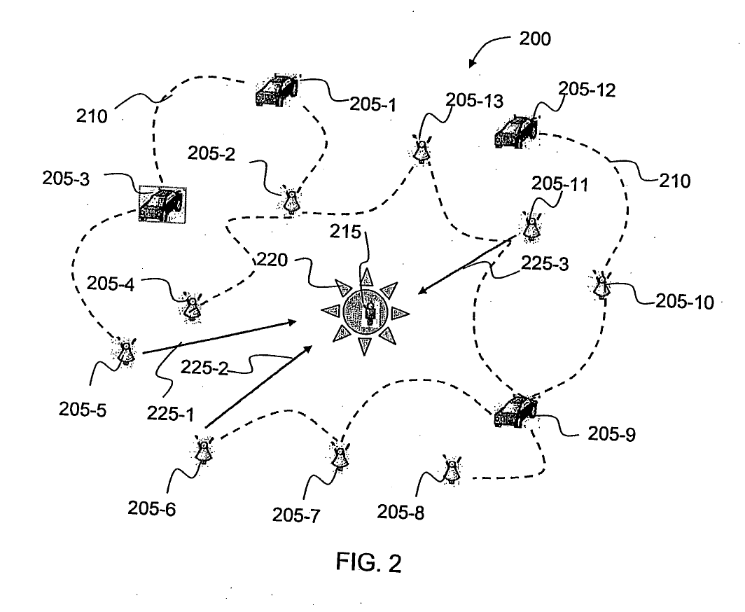

Referring to FIG. 2, there is a schematic diagram of a communication network 200 comprising a plurality of current network member nodes 205-n, according to an embodiment of the present invention. The network 200 may be, for example, a wireless Mobile Ad Hoc Network (MANET), and the nodes 205-n may be associated with mobile devices such as mobile phones or handheld radios, or with fixed devices such as Base Transceiver Stations (BTSs) or routers. For example a node 205-n may act as a wireless local area network (WLAN) access point (AP) comprising a router that is positioned on a light pole in a metropolitan area. As illustrated, some of the nodes 205-n are operating from individual people who are network users and some are operating from vehicles. The nodes 205-n are communicatively coupled as represented by dashed lines 210, indicating that the nodes 205-n are current members in the network 200. An external node 215 is shown surrounded by current network member nodes 205-n but is not connected to any current network member nodes 205-n, indicating that the node 215 is currently not a member of the network 200. As described in more detail below, the present invention concerns decreasing inter-node communications concerning network topology discovery, by eliminating unnecessary transmissions between the external node 215 and existing network member nodes 205-n.

Similar to the external node 115 in the network 100, according to the prior art as described above, the external node 215 in the network 200, according to an embodiment of the present invention, first announces its presence to the current network member nodes 205-n by broadcasting a topology discovery signal such as a “hello” message to the network 200. The star burst pattern 220 surrounding the external node 215 indicates a broadcast of a “hello” message from the external node 215 to surrounding current network member nodes 205-n. The “hello” message may be received by a plurality of current network member nodes 205-n. However, not all of the current network member nodes 205-n that receive the “hello” message will transmit a reply to the external node 215. Rather, according to an embodiment of the present invention, each current network member node 205-n that receives the “hello” message will first apply a response shedding rule that determines whether a response should be sent. Thus in FIG. 2, although ten or more of the nodes 205-n surrounding the external node 215 may have received the “hello” message broadcast from the external node 215, only three nodes 205-5, 205-6, 205-11 are shown as responding to the “hello” message, as indicated by the three arrows 225-1, 225-2, 225-3, respectively, pointing at the external node 215.

Within the present specification, a response shedding rule refers to any type of rule that can be used by a wireless communication node to indicate that only a limited number of responses to a message are sought. Thus a shedding rule results in a reduced amount of network signal traffic, where redundant and unnecessary potential response messages are “shed” and not sent. Because redundant potential response messages are not sent, network signal traffic congestion is reduced, nodes that do not send a response message based on the response shedding rule are able to conserve battery power, and overall network Quality of Service (QoS) for network users is increased.

One example of a response shedding rule states that only current network member nodes 205-n that have a medium access control (MAC) address that is an even number should respond to a “hello” message from the external node 215. A MAC address is a hardware address that uniquely identifies each node of a network. Thus, statistically, such a rule should result in a fifty percent reduction in a number of responses to a “hello” message, as half of the nodes 205-n that receive a hello message are likely to have an even MAC address and respond, and half of the nodes 205-n will have an odd MAC address and will not respond.

Depending on the size of a network, other types of response shedding rules can be applied. For example, in a large network with a large number of current member nodes that might receive a “hello” message, a response shedding rule may prescribe that only nodes with a MAC address that ends in a digit equal to n, where n is selected randomly from the set [0 to 9], should reply. Assuming that MAC addresses are assigned randomly, such a rule will statistically result in a ninety percent reduction in a number of responses to the “hello” message, as only one in ten nodes will respond. If an external node does not receive a response from any current network member nodes after application of such a response shedding rule, another digit n can be randomly selected, and the “hello” message can be rebroadcast to the network. Such incremental changes to the response shedding rule can continue until a response is received.

Another example of a response shedding rule according to an embodiment of the present invention prescribes that only nodes with a MAC address that is divisible by three should respond. That will result in the elimination, or shedding, of two third's of potential responses. Still other examples of response shedding rules can concern features of Internet Protocol (IP) addresses of current network member nodes 205-n, or features of hash values of node names, where ASCII (American Standard Code for Information Interchange) characters are determined as hex values byte by byte. Many other types of response shedding rules are also within the scope of the present invention, as will be appreciated by those skilled in the art in light of the present specification.

A response shedding rule according to an embodiment of the present invention can be determined in various ways and by various entities. For example, the external node 215 can determine a response shedding rule and then transmit the response shedding rule with the first topology discovery signal, such as a “hello” message, that the external node 215 broadcasts to the network 200. In such a situation, the external node 215 can determine the response shedding rule based on observations that the node 215 makes about the network 200 before transmitting the first topology discovery signal. For example, if the external node 215 observes a significant volume of network signal traffic that is received at the node 215 with a high received signal strength indicator (RSSI), then the node 215 may choose to apply an aggressive response shedding rule that will eliminate a majority of potential responses. Alternatively, if very little network signal traffic is observed, then the node 215 may choose to apply a conservative response shedding rule that will eliminate only a small number of potential responses.

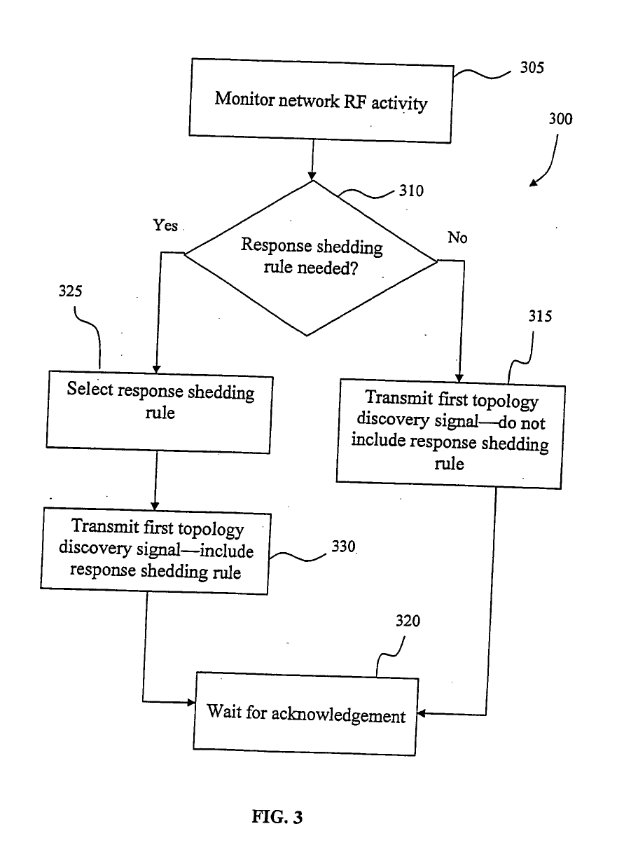

Referring to FIG. 3, a general flow diagram illustrates a method 300 for topology discovery in an ad hoc wireless communication network, from the perspective of an external node, according to an embodiment of the present invention. At step 305, an external node monitors RF activity of an existing ad hoc network. For example, referring again to the network 200, the external node 215 monitors the RF communications between the current network member nodes 205-n. Based on a level of network RF activity, at step 310 it is determined whether or not a response shedding rule is required/desired to be applied concerning responses to a “hello” message broadcast from the external node. If not, at step 315 a first topology discovery signal, such as a broadcast “hello” message, is transmitted from the external node and the application of a response shedding rule is not requested. At step 320, the external node then waits for a second topology discovery signal such as an acknowledgement response from a current network member node.

If at step 310 it is determined that a response shedding rule is desired/required, then at step 325, based on an observed level of network RF activity, a particular response shedding rule is selected. For example, if a lot network RF activity is observed by the external node, an aggressive response shedding rule may be selected; whereas if only a modest level of network RF activity is observed by the external node, then a conservative response shedding rule may be selected. At step 330, a first topology discovery signal, such as a broadcast “hello” message, which signal includes the selected response shedding rule, is transmitted from the external node. The method 300 then continues at step 320, where the external node waits for a second topology discovery signal such as an acknowledgement response from a current network member node.

According to another embodiment of the present invention, a response shedding rule can be determined by a current network member node 205-n. Current network member nodes 205-n may possess a significant amount of information concerning a topology of the network 200, and therefore can intelligently decide whether to apply an aggressive or a conservative response shedding rule. Thus it is possible for different current network member nodes 205-n to apply different response shedding rules to the same “hello” message broadcast from the external node 215. Nevertheless, an objective of embodiments of the present invention which is to reduce unnecessary network signaling still will be achieved. Further, according to some embodiments of the present invention, current network member nodes 205-n can add new response shedding rules in addition to response shedding rules that are received from the external node 215, or can change or modify response shedding rules received from the external node 215.

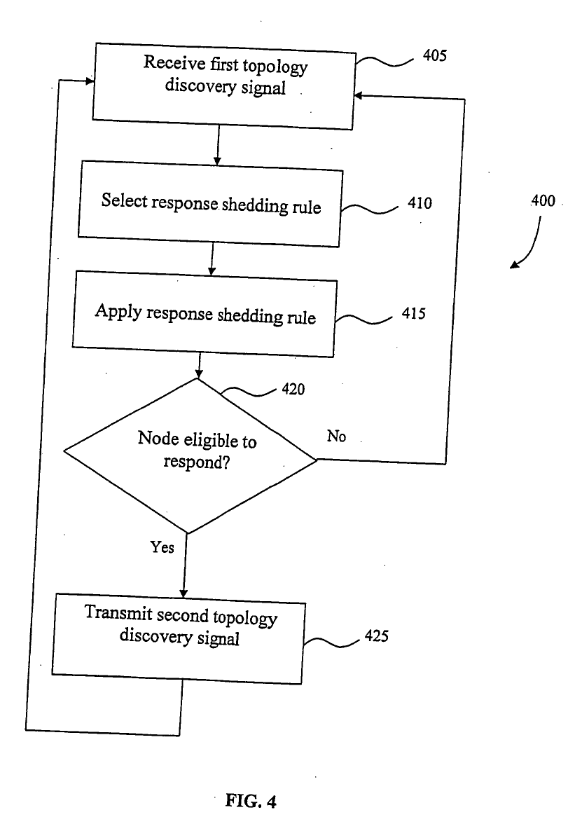

Referring to FIG. 4, a general flow diagram illustrates a method 400 for topology discovery in an ad hoc wireless communication network, from the perspective of a current network member node, according to an embodiment of the present invention. At step 405, a first node receives a first topology discovery signal transmitted from a second node in the network. For example, a current network member node 205-n receives a “hello” message from the external node 215 in the network 200. At step 410, a response shedding rule is selected from a plurality of possible response shedding rules based on a topology characteristic of the network. For example, a current network member node 205-n may select either an aggressive or a conservative response shedding rule based on a level of network signal traffic in the network 200. At step 415, the selected response shedding rule is applied to the first node. At step 420, it is determined whether, based on the response shedding rule, the first node is eligible to respond to the first topology discovery signal. If not, then the method 400 cycles back to step 405 and the first node waits until a subsequent topology discovery signal is received. However, if at step 420 it is determined that the first node is eligible to respond to the first topology discovery signal, then the method 400 continues at step 425 where the first node transmits to the second node, in response to the first topology discovery signal, a second topology discovery signal. For example, a current network member node 205-n transmits to the external node 215 a response to a “hello” message that provides instructions about how to join the network 200. The method 400 then cycles back to step 405 and the first node waits until a subsequent topology discovery signal is received.

Those skilled in the art will recognize that the present invention can be embodied in a wireless electronic device, such as a device associated with a current network member node 205-n or the external node 215. The device can be, for example, a mobile phone, handheld radio device, personal digital assistant (PDA), notebook computer, base transceiver station (BTS), or network router. The device can include a standard microprocessor or ASIC operatively connected to a computer readable medium such as a random access memory (e.g., static random access memory (SRAM)), read only memory (e.g., programmable read only memory (PROM), or erasable programmable read only memory (EPROM)), or hybrid memory (e.g., FLASH) as is well known in the art. The medium then comprises computer readable program code components that, when processed by the microprocessor, are configured to execute the above described steps of the methods 300 or 400.

Advantages of embodiments of the present invention thus include a reduced number of unnecessary and redundant network signaling messages in an ad hoc wireless communication network. That results in reduced network signaling congestion, reduced RF interference, and a reduced use of network resources such as node processing resources and node battery power. That in turn results in increased network efficiency and improved Quality of Service (QoS) for network users.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A method for topology discovery in an ad hoc network, the method comprising:
receiving, at a first node, a first topology discovery signal transmitted from a second node;
applying a response shedding rule to the first node;
determining, based on the response shedding rule, that the first node is eligible to respond to the first topology discovery signal; and
transmitting, in response to the first topology discovery signal, from the first node to the second node a second topology discovery signal.

2. The method of claim 1, wherein the first topology discovery signal includes the response shedding rule.

3. The method of claim 1, wherein the response shedding rule defines a feature of a medium access control (MAC) address, an Internet Protocol (IP) address, or a name of the first node.

4. The method of claim 1, wherein the first topology discovery signal comprises a “hello” message that is a first signal received from the second node.

5. The method of claim 1, further comprising selecting the response shedding rule from a plurality of possible response shedding rules based on a topology characteristic of the network.

6. The method of claim 5, wherein selecting the response shedding rule from a plurality of possible response shedding rules based on a topology characteristic of the network is performed at the first node.

7. The method of claim 5, wherein selecting the response shedding rule from a plurality of possible response shedding rules based on a topology characteristic of the network is performed at the second node.

8. The method of claim 5, wherein the topology characteristic of the network is selected from a group comprising: node locations, node transmitting power, the existence of a node, node battery status, the willingness of a node to act as an intermediate node for relaying transmissions between other nodes, received signal strength indicators (RSSIs), levels of network signal traffic congestion, a number of nodes participating in a network, and levels of radio frequency interference.

9. The method of claim 1, wherein the first node is a current member of the network and the second node is not a current member of the network.

10. A system for topology discovery in an ad hoc network, comprising:
computer readable program code components configured to receive, at a first node, a first topology discovery signal transmitted from a second node;
computer readable program code components configured to apply a response shedding rule to the first node;
computer readable program code components configured to determine, based on the response shedding rule, that the first node is eligible to respond to the first topology discovery signal; and
computer readable program code components configured to transmit, in response to the first topology discovery signal, from the first node to the second node a second topology discovery signal.

11. The system of claim 10, wherein the first topology discovery signal includes the response shedding rule.

12. The system of claim 10, wherein the response shedding rule defines a feature of a medium access control (MAC) address, an Internet Protocol (IP) address, or a name of the first node.

13. The system of claim 10, wherein the first topology discovery signal comprises a “hello” message that is a first signal received from the second node.

14. The system of claim 10, further comprising computer readable program code components configured to select the response shedding rule from a plurality of possible response shedding rules based on a topology characteristic of the network.

15. The system of claim 14, wherein selecting the response shedding rule from a plurality of possible response shedding rules based on a topology characteristic of the network is performed at the first node.

16. The system of claim 14, wherein selecting the response shedding rule from a plurality of possible response shedding rules based on a topology characteristic of the network is performed at the second node.

17. The system of claim 14, wherein the topology characteristic of the network is selected from a group comprising: node locations, node transmitting power, the existence of a node, node battery status, the willingness of a node to act as an intermediate node for relaying transmissions between other nodes, received signal strength indicators (RSSIs), levels of network signal traffic congestion, a number of nodes participating in a network, and levels of radio frequency interference.

18. The system of claim 10, wherein the first node is a current member of the network and the second node is not a current member of the network.

19. A system for topology discovery in an ad hoc network, comprising:
means for receiving, at a first node, a first topology discovery signal transmitted from a second node;
means for applying a response shedding rule to the first node;
means for determining, based on the response shedding rule, that the first node is eligible to respond to the first topology discovery signal; and
means for transmitting, in response to the first topology discovery signal, from the first node to the second node a second topology discovery signal.
